(19) United States
(12) Patent Application Publication
(10) Pub. No.: US 2022/0358505 A1
(43) Pub. Date: Nov. 10, 2022

(54) ARTIFICIAL INTELLIGENCE (AI)-BASED DETECTION OF FRAUDULENT FUND TRANSFERS

(71) Applicant: Bank of America Corporation, Charlotte, NC (US)

(72) Inventors: Sophie Morgan Danielpour, New York, NY (US); Meaghan Welch, Tega Cay, SC (US); Sean Kowalski, Huntersville, NC (US)

(21) Appl. No.: 17/307,244

(22) Filed: May 4, 2021

(51) Int. Cl. G06Q 20/40; G06N 20/00; G06N 5/04; G06Q 40/02

(52) U.S. Cl. CPC G06Q 20/4016; G06N 20/00; G06N 5/04; G06Q 40/02; G06Q 20/407

(57) ABSTRACT

Aspects of this disclosure relate to use of a monitoring platform in an electronic fund transfer network for detection of fraudulent fund transfers. The monitoring platform may use a database of accounts known to be associated with malicious activity in combination with an ML engine for the detection. The ML engine may be trained, using supervised machine learning, to identify fraudulent fund transfers based on various parameters associated with fund transfer requests. The monitoring platform may review the requests in near real-time and cancel or recall fraudulent requests.

### TECHNICAL FIELDS

Aspects described herein generally relate to automated detection of fraudulent electronic fund transfers, and more specifically to use of artificial intelligence (AI)-based technologies for the detection.

### BACKGROUND

Malicious actors typically use money mules to transfer illegally-obtained money (e.g., proceeds of money laundering, online fraud, or other scams) between different accounts. For example, a money mule may be asked to accepts funds at a source account associated with the money mule and initial an electronic wire transfer to a destination account (often a foreign account). The destination account may be associated with the malicious actor themselves, or with another money mule. This chain of transactions between different accounts enables obscuring of a source of funds and further enables the malicious actors to distance themselves from this fraudulent activity. Detection of such transfers remains a challenge for financial institutions.

While financial institutions may have internal and external databases that list details of accounts known to be associated with suspicious/fraudulent activity, these databases may not necessarily be accurate and/or may result in detection of false positives. As a consequence, the use of the databases must be supplemented with manual oversight for detecting and stopping of fraudulent transfers, resulting in delayed detection.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the problems associated with detection of suspicious fund transfer activity between different accounts. Various embodiments described herein may use artificial intelligence (AI)-based techniques for the detection. For example, the AI-based techniques may comprise using supervised machine learning (ML) to accurately determine suspicious fund transfers with minimal or no manual oversight. Various embodiments herein may also use supervised ML to determine indicators of compromise (IOC) that may be used for automated detection of suspicious fund transfers.

In accordance with one or more arrangements, a machine learning system may be used to filter false positive fund transfer requests. The system may comprise a mule account database with a listing of accounts, a user computer device, a machine learning (ML) engine, a monitoring platform, and an enterprise user computing device. The user computer device may be configured to send a request for a fund transfer. The request may comprise an indication of a source account, an indication of a destination account, and an indication of a transfer value. The ML engine may be trained using supervised machine learning based on transfer information and response notifications (e.g., from the enterprise user computing device). The monitoring platform may compare the source account and the destination account with accounts listed in the mule account database. The monitoring platform may, based on at least one of the source account and the destination account matching the accounts listed in the mule account database, send first transfer information to the enterprise user computing device. The first transfer information may comprise the indication of the source account, the indication of the destination account, the indication of the transfer value, and indications of transfer parameters associated with the request. The monitoring platform may receive, from the enterprise user computing device, a response notification. The response notification may indicate whether the request is for a fraudulent fund transfer. The response notification is used as a feedback signal for the ML engine. The monitoring platform may send, to a server associated with a fund transfer network and based on receiving the response notification, a transfer notification that causes the fund transfer network to process the request for the fund transfer.

In some arrangements, the transfer parameters may comprise one of: a date of the request; a date of entry of the source account in the mule account database; a date of entry of the destination account in the mule account database; a beneficiary name associated with the destination account, contents of a memo field in the request; and combinations thereof.

In some arrangements, the response notification may indicate that the request is for a fraudulent fund transfer. The transfer notification may indicate cancelation of the request based on the response notification indicating that the request is for a fraudulent fund transfer. The server associated with the fund transfer network may cancel the request based on the transfer notification. The monitoring platform may, based on the response notification indicating that the request for the fund transfer is for a fraudulent fund transfer and at least one of the source account and the destination account not being listed in the mule account database, add the at least one of the source account and the destination account to the mule account database.

In some arrangements, the response notification may indicate that the request is approved. The transfer notification may indicate that the request is approved based on the response notification may indicating that the request is approved. The server associated with the fund transfer network may approves the request based on the transfer notification.

In some arrangements, a second user computer device may send a second request for a second fund transfer. The second request may comprise: an indication of a second source account; an indication of a second destination account; and an indication of a second transfer value. The monitoring platform may receive the second request, and compare the second source account and the second destination account with accounts listed in the mule account database. The monitoring platform may, based on at least one of the second source account and the second destination account matching the accounts listed in the mule account database, use the ML engine to determine whether the second request is for a fraudulent fund transfer. Determining whether the second request is for a fraudulent fund transfer may be based on the second transfer value, and second transfer parameters associated with the second request. The monitoring platform may send, to the server associated with a fund transfer network and based on determining whether the second request is for a fraudulent fund transfer, a second transfer notification.

In some arrangements, the second transfer parameters may comprise one of: a date of the second request; a date of entry of the second source account in the mule account database; a date of entry of the second destination account in the mule account database; a beneficiary name associated with the second destination account; contents of a memo field in the second request;

and combinations thereof.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 shows an example method for detection of suspicious fund transfer based on a database of known mule accounts, in accordance with one or more aspects described herein;

FIG. 2 shows an example output file as generated by a system for detecting suspicious fund transfers, in accordance with one or more aspects described herein;

FIG. 3 shows an example method for batch-mode detection of fraudulent fund transfers, in accordance with one or more aspects described herein;

FIG. 4 shows an example of real-time monitoring and detection of fraudulent fund transfers, in accordance with one or more aspects described herein;

FIG. 5 shows an example event sequence for detection of fraudulent fund transfers, in accordance with one or more aspects described herein;

FIG. 6 shows an example event sequence for real-time detection of fraudulent fund transfers, in accordance with one or more aspects described herein; and

FIG. 7 shows an example event sequence for supervised machine learning of the ML engine, in accordance with one or more aspects described herein.

FIG. 8A shows an illustrative computing environment determination of fraudulent transfers, in accordance with one or more aspects described herein;

FIG. 8B shows an example monitoring platform, in accordance with one or more aspects described herein;

FIG. 9 shows a simplified example of an artificial neural network on which a machine learning algorithm may be executed, in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect. The examples and arrangements described are merely some example arrangements in which the systems described herein may be used. Various other arrangements employing aspects described herein may be used without departing from the invention.

Monitoring of fund transfers (e.g., wire transfers, automatic clearing house (ACH) transfers, ZELLE transfers, transfers in accordance with any other electronic fund transfer (EFT) systems/protocols) for detecting suspicious activity remains a challenging task for financial institutions. Suspicious activity may include use of money mules (often unwitting actors) for initiating transfers, in a chain of transfers involving multiple intermediary accounts, from a source account to a destination account. Such transactions are often used for illegal activities (e.g., money laundering, transferring funds obtained using online scams, etc.) while remaining anonymous to law enforcement agencies. Although financial institutions may maintain databases listing accounts suspected to be associated with illegal activities, the use of money mules may result in detection of such fund transfers only after a fund transfer has been completed and funds withdrawn at a destination account. Oversight mechanisms at financial institutions often involve manual inspection which may result in further delays in detection of illegal transfers. Additionally, the use of databases may result in detection of a large quantity of false positives (e.g., because the database may not be updated frequently) even though the transactions may be legal.

Various examples described herein describe the use of artificial intelligence (AI)-based approaches for detection of fraudulent transfers. The AI-model may be trained (e.g., using supervised machine learning (ML) techniques to detect other indicators of compromise (IOC) to detect fraudulent transactions. The IOCs may include, but are not limited to, memo line terms used for fund transfers, destination countries of the fund transfers, a value of the fund transfer, a determination of whether the fund transfer is an inter-bank transfer, addresses associated with destination accounts, etc. Further, the AI model may be used to continuously validate and/or update the database of accounts suspected to be associated with illegal activities. The various procedures described herein may ensure automated and accurate determination of fraudulent transfers. Further, validation of databases may ensure reduced detection of false positives, thereby improving quality of services provided to legitimate users.

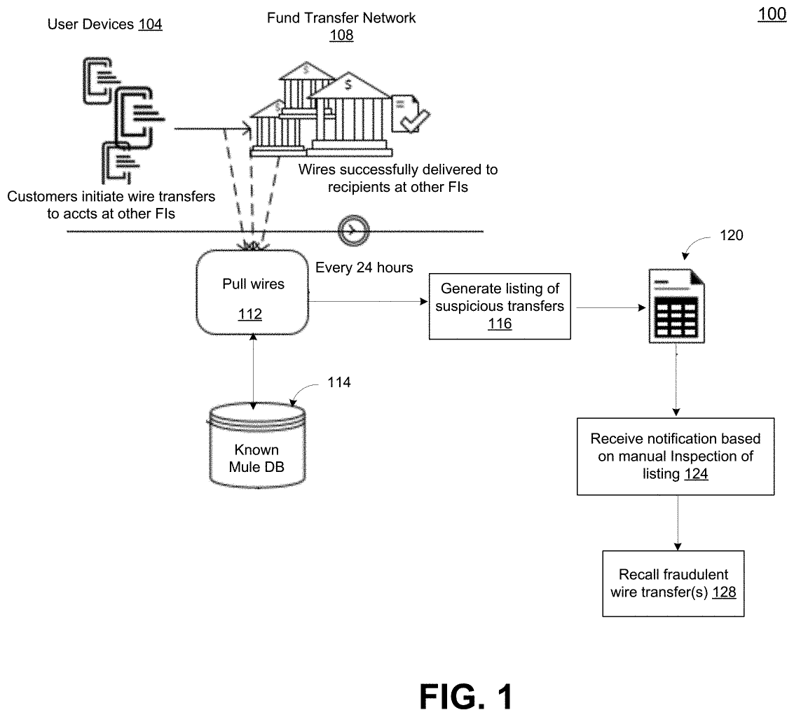

FIG. 1 shows an example method 100 for detection of suspicious fund transfers based on a database of known mule accounts. The fund transfers may be transfers from accounts associated with a source financial institution (e.g., a bank) to external accounts associated with a destination financial institution. One or more server(s) (e.g., monitoring server(s), server(s) associated with a fund transfer network, etc.) may implement one or more of the steps described with reference to FIG. 1. The one or more server(s) may be associated with the source financial institution. While FIG. 1 illustrates the method 100 as applied for wire transfers, the method 100 may be used for any electronic fund transfer (EFT) system.

User devices 104 may be used to initiate fund transfers from a source account to a destination account. User device(s) 104 may correspond to personal device(s) (e.g., smartphones, personal computers, etc.) associated with clients of the source financial institution, or an enterprise device of the source financial institution that may be used to request the fund transfers. Based on receiving a request from a user device 104, the fund transfer network may process a transfer from a source account to a destination account.

At step 112, a monitoring server may determine processed transfers, from accounts associated with the source financial institutions, to external accounts. The determination may be performed periodically (e.g., every 6 hours, 12, hours, 24 hours, etc.). The monitoring server may further compare the accounts associated with the determined transfers (e.g., source accounts, destination accounts) with a mule database 114 of accounts that are flagged as being associated with suspected illegal activity (e.g., mule accounts). If an account associated with the transfer is present in the mule database 114, the transfer may be flagged as being suspicious.

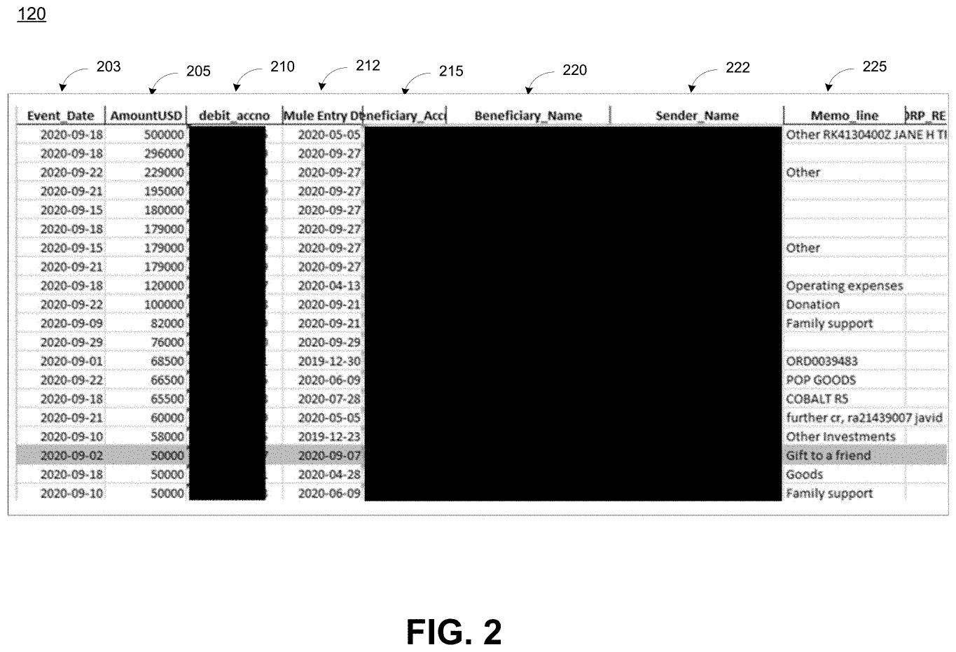

At step 116, the monitoring server may generate a listing 120 of suspicious transfers among the processed transfers. FIG. 2 shows the listing 120 of suspicious transfers along the various parameters that may be associated with the suspicious transfers. The parameters may include one or more of: an event date 203 (e.g., date when transfer was requested/processed), an amount 205 (e.g., in US dollars) of fund transfer, a source/debit account number 210, an entry date 212 of the source account/destination account in the mule database 114, a destination/beneficiary account number 215, a beneficiary name 220 associated with the destination account, contents of a memo field of a fund transfer request 225, etc. The listing 120 may be presented to a user (e.g., an employee associated with the source financial institution) for review. The user may determine that one or more of the suspicious transfers in the listing 120 are fraudulent (e.g., based on manual inspection of the listing 120).

The user may send a notification, to the monitoring server, indicating the one or more of the suspicious transfers that are determined to be fraudulent. At step 124, the monitoring server may receive the notification. At step 128, the monitoring server may send one or more messages to server(s) in the fund transfer network to recall the fraudulent wire transfers.

There are multiple issues with respect to the above approach for detecting and reversing fraudulent transfers. The listing 120 may have a high proportion of false positives. This may be because accounts in the listing may not be frequently validated to confirm that they are associated with fraudulent activity. An account may be included in the listing but may later be determined to be not associated with fraudulent activity. However, the listing may not be updated to reflect this change in status. As a result, the listing may include accounts that are inactive or not associated with malicious activity. Further, different banks may have accounts that have same/similar account numbers. Any of these reasons may result in a determination that a transfer is suspicious even if that is not the case. Higher proportion of false positives in determination of suspicious transfers may result in increased manual effort to detect actual fraudulent transfers. Various examples herein use other parameters associated with a fund transfer (e.g., event date 203, amount 205, a source/debit account number 210, an entry date 212, a destination/beneficiary account number 215, a beneficiary name 220, memo field 225, etc.) to reduce the quantity of false positives. The use of an ML engine for determination of suspicious and/or fraudulent fund transfers may completely eliminate the need for manual oversight of the process.

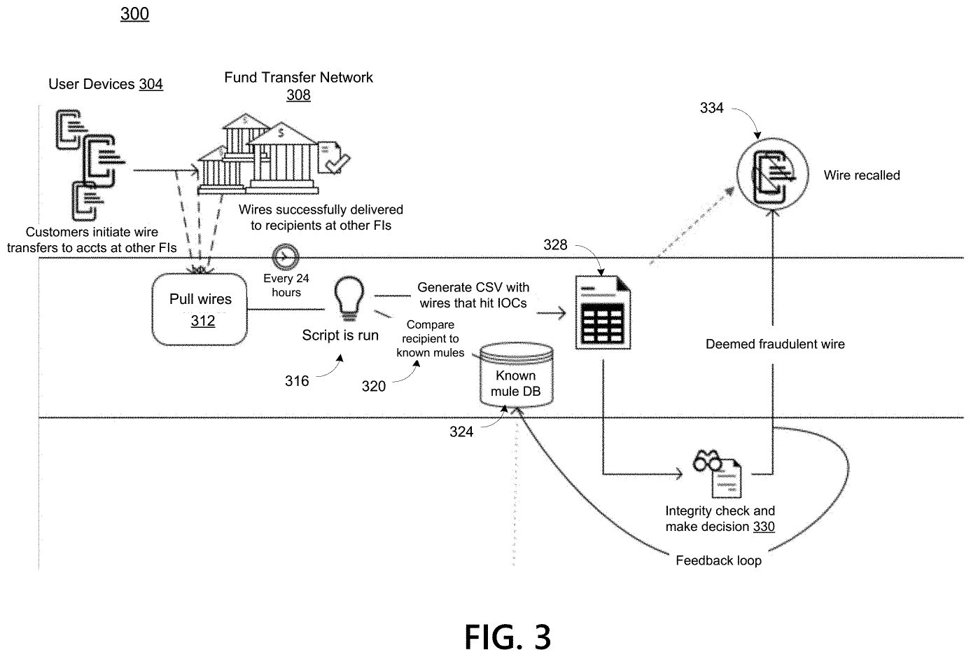

FIG. 3 shows an example method 300 for batch-mode detection of fraudulent fund transfers. The method 300 may be used to detect fraudulent fund transfers based on a listing of mule accounts and further based on other parameters associated with fund transfers. The fund transfers may be from accounts associated with a source financial institution to external accounts associated with a destination financial institution. One or more server(s) (e.g., monitoring server(s), server(s) associated with a fund transfer network, etc.) may implement one or more of the steps described with reference to FIG. 3. The one or more server(s) may be associated with the source financial institution. While FIG. 3 illustrates the method 300 as applied for wire transfers, the method 300 may be used for any electronic fund transfer (EFT) system.

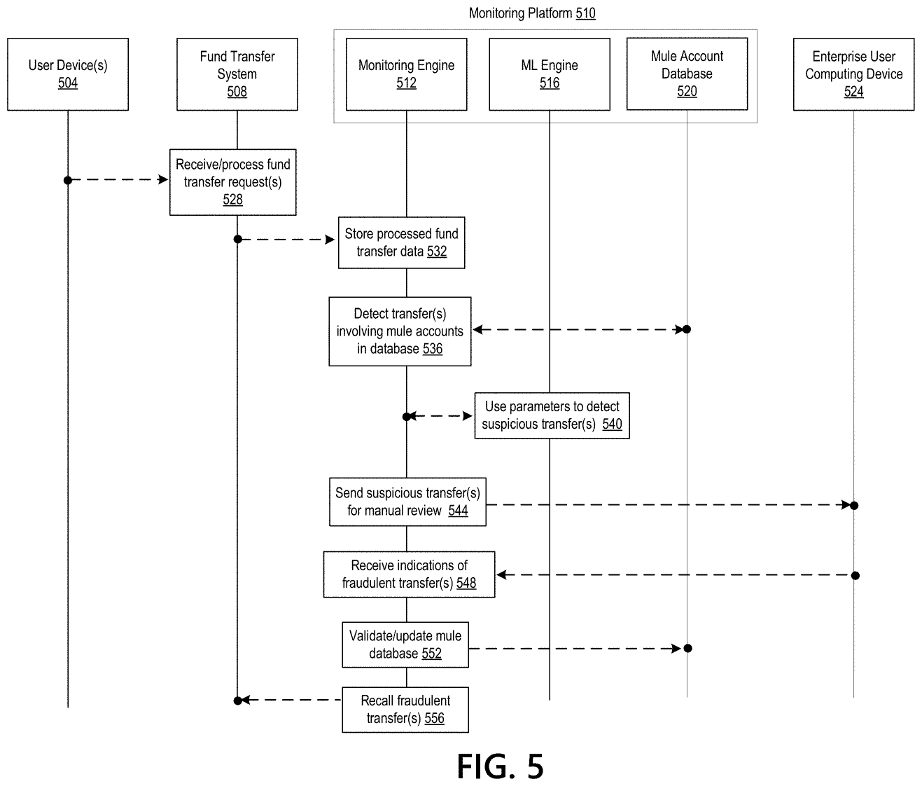

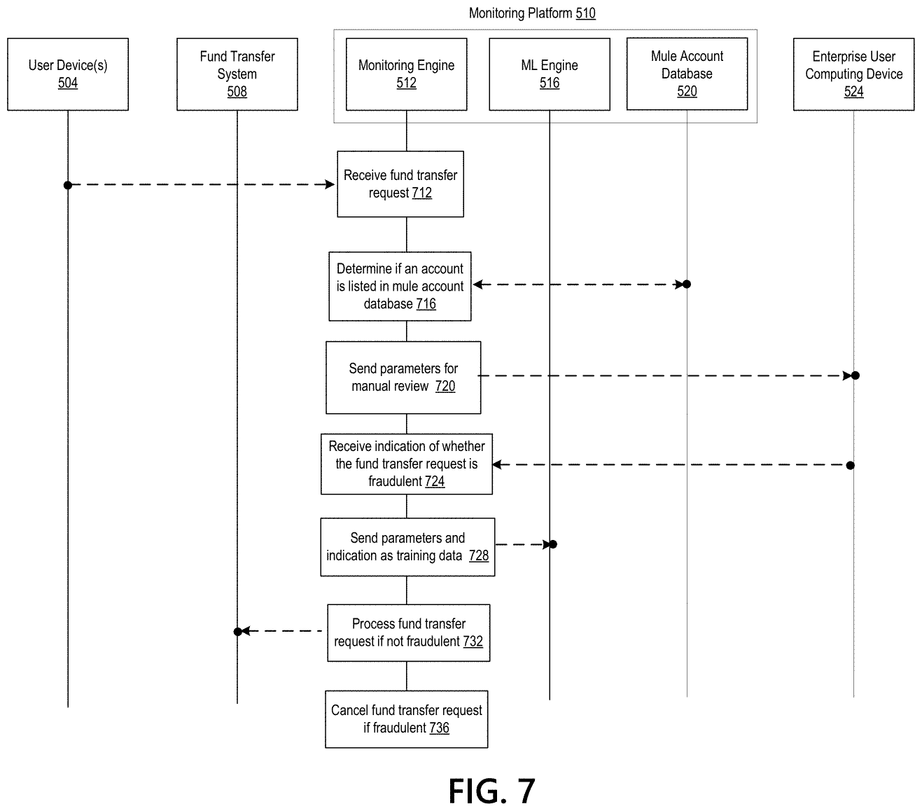

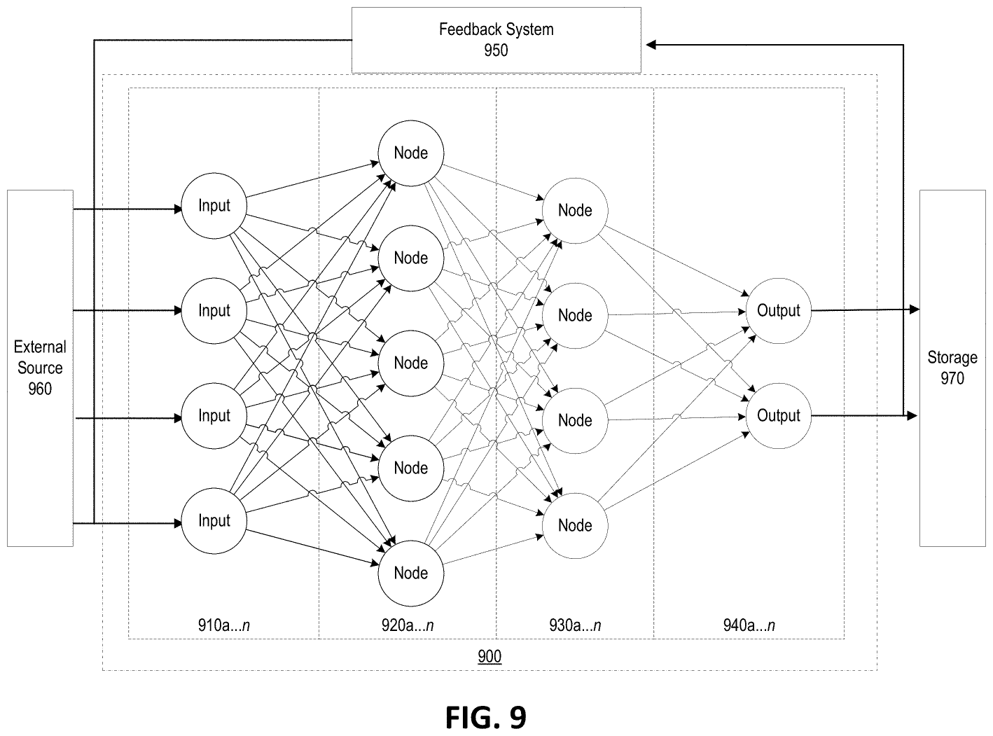

At step 312, a monitoring server may determine processed fund transfers, from accounts associated with the source financial institutions, to the external accounts. The determination may be performed periodically (e.g., every 6 hours, 12, hours, 24 hours, etc.). A script may be executed (e.g., step 316) at the monitoring server to determine suspicious transfers among the processed transfers. The monitoring server may compare (e.g., step 320) accounts associated with the processed transfers with accounts listed in the mule database 324 (e.g., as described with respect to FIG. 1). Further, the script may use presence of specific values of parameters in the processed transfers (e.g., event date 203, amount 205, a source/debit account number 210, an entry date 212, destination/beneficiary account number 215, beneficiary name 220, memo field 225, etc.) as IOCs for determining the suspicious fund transfers. An ML engine (e.g., described with respect to FIG. 5), associated with the monitoring server, may be used to determine suspicious fund transfers based on the parameters. The ML engine may be trained to detect suspicious fund transfers using supervised ML techniques (e.g., as described with respect to FIG. 7). Determination of suspicious fund transfers need not be based on one specific condition associated with one of the parameters, but may be based on processing of the parameters as a whole by the ML engine. For example, a neural network (e.g., as described with respect to FIG. 9) may be trained to identify suspicious transfers. Input to the neural network may be one or more parameters of the processed transfers.

In an example, a value of the fund transfer may be used to determine whether a transfer is suspicious. The monitoring server may determine that a transfer is suspicious if a value of the transfer is greater than a threshold and/or if the value of the transfer is an even dollar amount (e.g., a multiple of 1000, 10000, etc.). In this example, the IOC may be the value of fund transfer being an even dollar amount.

In an example, terms used in a memo field of the fund transfer may be used to determine whether a transfer is suspicious. The monitoring server may determine that a transfer is suspicious if specific terms in the memo field are detected. For example, with reference to listing 120, the monitoring server may determine that transfers with the memo field terms “POP GOODS” or “family support” is a suspicious transfer. The monitoring server may store a listing of memo field terms associated with suspicious transfers. In this example, the IOC may be detection of specific terms in the memo field.

Terms in memo fields identified to be potentially associated with suspicious transfers need not exactly match with terms used in actual fund transfers. For example, the phrase “POP GOODS” may be written as “POP GOOD,” “P GOODS,” or “PG,” and the phrase “family support” may be written as “fam support,” “fam support,” or “family.” Further, there may be spelling errors in the memo field terms (e.g., “famly support,” “family suport”). The monitoring server may normalize the memo field terms and use fuzzy logic to ensure that these discrepancies are accounted for and/or corrected for determination of suspicious transfers. In an example, data in the memo line fields may be normalized to account for any discrepancies between different users.

In an example, a beneficiary name associated with the destination account the fund transfer may be used to determine whether a transfer is suspicious. The monitoring server may determine that a transfer is suspicious if beneficiary name comprises certain terms (e.g., LLC). In this example, the IOC may be detection of specific terms in the beneficiary name.

In an example, an address associated with the destination financial institution and/or an address associated with the beneficiary may be used to determine whether a transfer is suspicious. The monitoring server may determine that a transfer is suspicious if an address corresponds to a particular designated country or region. For example, the designated country or region may be known to be associated with a higher incidence of fraudulent transfers. In this example, the IOC may be a determination that the destination account is linked to specific countries or regions.

In an example, a tenure/age of an account (e.g., the source account and/or the destination account) may be used to determine whether a transfer is suspicious. For example, if the destination account (or the source account) is a new account or a relatively new account, the monitoring server may determine the transfer to be suspicious. An account may be classified as a new account, for example, based on the account being created within a threshold time period prior to a request for a fund transfer or a processed fund transfer (e.g., within two days, within a week, etc.). In this example, the IOC may be a tenure of an account associated with a fund transfer.

In an example, one or more of the above conditions may be used in response to determining that the destination account for the fund transfer is an external account at a financial institution different from a source financial institution associated with the source account. The ML engine may use the parameters of a fund transfer to determine whether the fund transfer is suspicious, for example, if the fund transfer is to an external account.

The monitoring server may generate a listing 328 of the suspicious fund transfers. At step 330, a user (e.g., an employee associated with the source financial institution) may review the listing 328 to determine fraudulent transfers. If any transfers in the listing 328 are determined to be fraudulent, the monitoring server may send indications to server(s) associated with the fund transfer system to recall the fraudulent fund transfers (e.g., step 334). In an example, manual review may be skipped, and the suspicious transfers in the listing 328 may be deemed to be fraudulent and recalled.

Source accounts and/or destination accounts associated with fraudulent fund transfers in the listing 328 may be added to the mule database 324 (e.g., if not already present). Source accounts and/or destination accounts in the mule database 324 may be validated (as being in active use for fraudulent transfers) if they match with accounts in the listing 328 that correspond to fraudulent fund transfers.

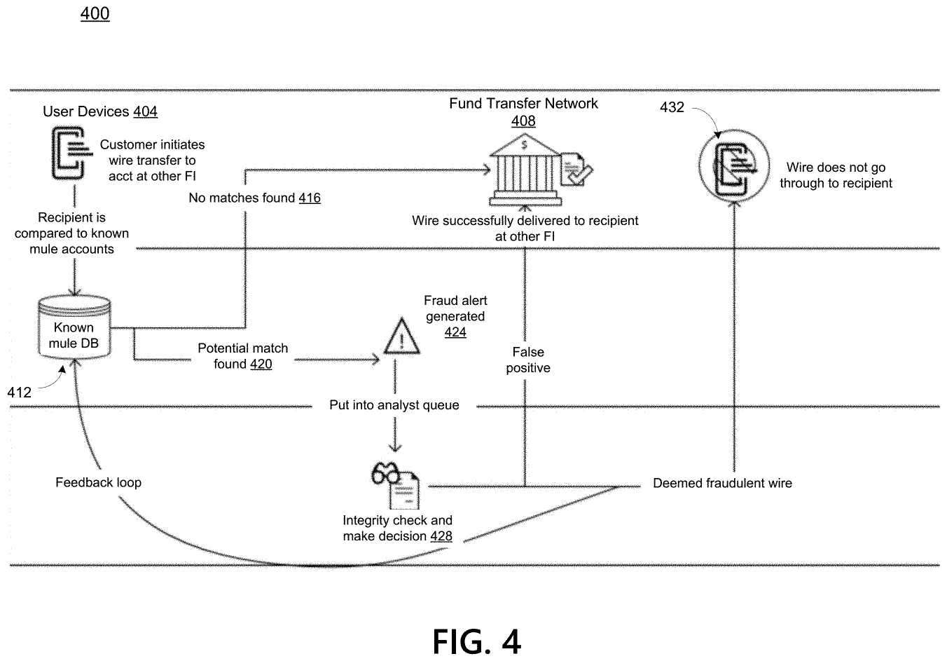

FIG. 4 shows an example of real-time monitoring and detection of fraudulent fund transfers. The method 400 may be used to detect fraudulent fund transfers based on a listing of mule accounts and further based on other parameters associated with fund transfers. The fund transfers may be from accounts associated with a source financial institution to external accounts associated with a destination financial institution. One or more server(s) (e.g., monitoring server(s), server(s) associated with a fund transfer network, etc.) may implement one or more of the steps described with reference to FIG. 4. The one or more server(s) may be associated with the source financial institution. While FIG. 4 illustrates the method 400 as applied for wire transfers, the method 400 may be used for any electronic fund transfer (EFT) system.

A user device 404 (e.g., a personal computing device, a smartphone) may send a fund transfer request for a transfer of funds from a source account (associated with a source financial institution) to a destination account (associated with a different, destination financial institution). The fund transfer request may comprise indications of the source account, the source financial institution, the destination account, the destination financial institution, and a value of the fund transfer. A monitoring server may receive the fund transfer request and compare the accounts associated with the request (e.g., source account, destination account) to accounts listed in a mule database 412. If none of the accounts associated with the request match accounts listed in the mule database 412 (step 416), the monitoring server may send an indication, to one or more servers associated with the fund transfer system, to process the fund transfer.

If one or more of the accounts associated with request match accounts listed in the mule database 412 (step 416), a fraud alert may be sent to an enterprise computing device (e.g., associated with an employee of the source financial institution). Sending the fraud alert may be further based on detection of one or more IOCs (e.g., as described with reference to FIG. 3) in parameters associated with the fund transfer request (e.g., event date, amount, entry date, beneficiary name, memo field, etc.). Sending the fraud alert may be based on using an ML engine to analyze the parameters of the fund transfer request (e.g., as described in FIG. 9). A user associated with the enterprise computing device may review the fund transfer request (step 428) to determine if the fund transfer request is fraudulent. If the fund transfer request is determined to be fraudulent, the enterprise computing device may send an indication, to one or more servers associated with the fund transfer system, to cancel the fund transfer (step 432). If the fund transfer request is determined to not be fraudulent, the enterprise computing device may send an indication, to one or more servers associated with the fund transfer system, to process the fund transfer (step 408).

In an arrangement, the monitoring server may in addition to or instead of sending the fraud alert, send an indication, to one or more servers associated with the fund transfer system, to cancel the fund transfer. In this case, manual review of the fund transfer request may not be necessary.

If the indication to cancel the fund transfer is sent, account(s) associated with fraudulent fund transfer request may be added to the mule database 412 (e.g., if not already present). Accounts in the mule database 412 may be validated (as being in active use for fraudulent transfers) if they match accounts associated with a canceled fund transfer request.

FIG. 5 shows an example event sequence for detection and recall of fraudulent fund transfers. The example event sequence may be used for batch mode detection of fraudulent transfers (e.g., in accordance with the method 300 of FIG. 3). User device(s) 504 may send requests for fund transfers to server(s) associated with a fund transfer system. The funds transfers may be from accounts associated with a source financial institution. At step 528, the server(s) may process the requests and send indications, for processing transfer of funds, to server(s) associated with destination financial institution(s).

A monitoring platform 510 may be used to monitor the fund transfers and detect fraudulent fund transfers. In an example, the monitoring platform 510 may be associated with the source financial institution. At step 532, a monitoring engine 512 of the monitoring platform 510 may determine and store the processed fund transfers. For example, the monitoring engine 512 may query the server(s) associated with a fund transfer system 508 to determine the processed fund transfers. The monitoring platform 510 may comprise (or be associated with) a mule account database 520 comprising a listing of accounts (e.g., associated with the source financial institution and/or the destination financial institution(s)) known to be potentially associated with fraudulent transfers and/or other malicious activity.

At step 536, the monitoring engine 512 may compare the accounts associated with the processed fund transfers (source accounts and/or destination accounts) with accounts in the mule account database 520. Based on the comparison, the monitoring engine may determine a set of fund transfers that involve accounts in the mule account database 520.

At step 540, an ML engine 516 may use various parameters associated with fund transfers, in the set of fund transfers, to determine suspicious fund transfers among the set of fund transfers. In an example, the ML engine 516 may use one or more of an event date, an amount, an entry date, a beneficiary name, a memo field, etc., associated with a fund transfer to determine if the fund transfer is suspicious. The ML engine 516 may use values of one or more of the above parameters as IOCs to detect suspicious fund transfers (e.g., as described with respect to FIG. 3).

At step 544, and based on the determination of the suspicious fund transfers by the ML engine 516, the monitoring platform 510 may send, to an enterprise user computing device 524, indications of the suspicious fund transfers. The enterprise user computing device 524 may be associated with the source financial institution. A user associated with the enterprise user computing device 524 may review the suspicious fund transfers and determine fraudulent fund transfers among the suspicious fund transfers. At step 548, the monitoring platform 510 may receive indications of the fraudulent fund transfers from the enterprise user computing device 524. In an arrangement, steps 544 and 548 may be skipped and the detected suspicious fund transfers by the ML engine 516 may be deemed to be fraudulent. This may reduce manual oversight and reduce time required for detection of fraudulent fund transfers.

At step 552, the monitoring engine 512 may update/validate accounts listed in the mule database 520 based on accounts associated with the fraudulent fund transfers (e.g., as described with respect to FIG. 3). Source accounts and/or destination accounts associated with fraudulent fund transfers may be added to the mule database 520 (e.g., if not already present). Source accounts and/or destination accounts in the mule database 520 may be validated (as being in active use for fraudulent transfers) if they match with accounts associated with the fraudulent fund transfers. At step 556, the monitoring platform 510 may send an indication, to the server(s) associated with the fund transfer system 508, to recall the fraudulent fund transfers.

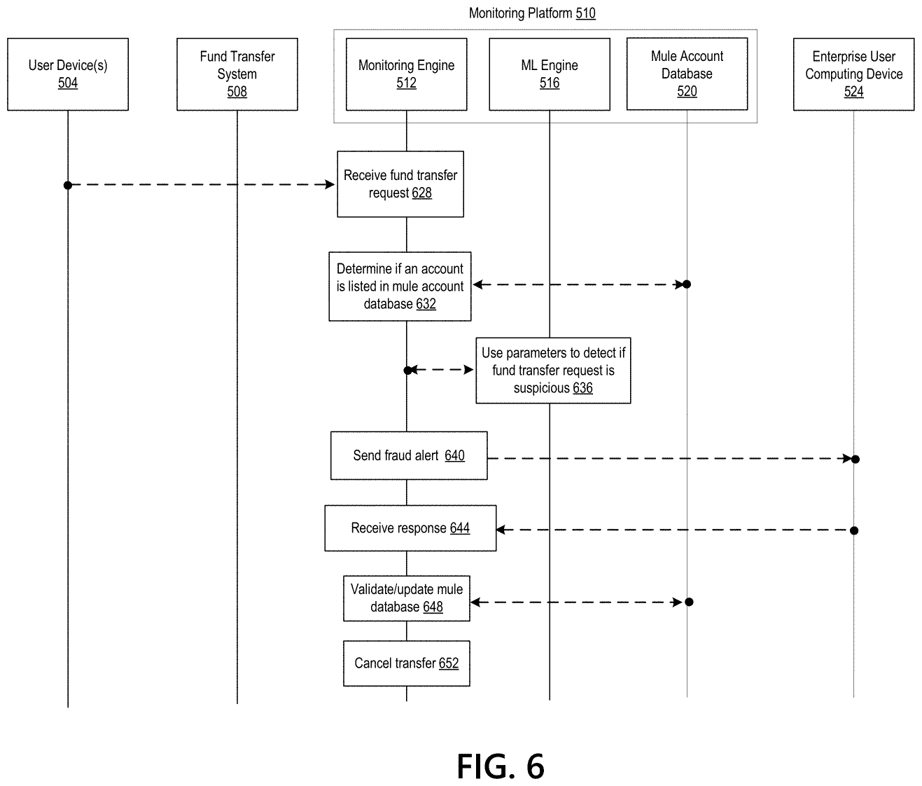

FIG. 6 shows an example event sequence for real-time detection and cancelation of a fraudulent fund transfer. A user device 504 may send a request for a fund transfer to the monitoring platform 512. The funds transfer may be from an account associated with a source financial institution to an account associated with a destination financial institution. The monitoring platform 510 may be used to detect if the fund transfer request is for a fraudulent fund transfer. In an example, the monitoring platform 510 may be associated with the source financial institution. At step 632, the monitoring engine 512 may compare the accounts associated with the fund transfer request (source account and/or destination account) with accounts in the mule account database 520. The mule account database 520 may comprise a listing of accounts (e.g., associated with the source financial institution and/or the destination financial institution) known to be potentially associated with fraudulent transfers and/or other malicious activity. Based on the comparison, the monitoring engine may determine whether an account associated with the fund transfer request is listed in the mule account database 520. If none of the accounts with the fund transfer request is listed in the mule account database 520, the monitoring engine 512 may approve the fund transfer request and send a notification to server(s) associated with the fund transfer system 508 to process the fund transfer request. If an account associated with the fund transfer request is listed in the mule account database 520, the ML engine 516 may be used to further determine if the fund transfer request is suspicious.

At step 636, the ML engine 516 may use various parameters associated with the fund transfer request to determine if the fund transfer request is suspicious. In an example, the ML engine 516 may use one or more of an event date, an amount, an entry date, a beneficiary name, a memo field, etc., associated with the fund transfer request to determine if the fund transfer request is suspicious. The ML engine 516 may use values of one or more of the above parameters as IOCs to detect if the fund transfer request is suspicious (e.g., as described with respect to FIG. 3). If fund transfer request is determined to be not suspicious, the monitoring engine 512 may approve the fund transfer request and send a notification to server(s) associated with the fund transfer system 508 to process the fund transfer request.

At step 640, and if the ML engine 516 determines that the fund transfer request is suspicious, the monitoring platform 510 may send, to an enterprise user computing device 524, a fraud alert. The enterprise user computing device 524 may be associated with the source financial institution. A user associated with the enterprise user computing device 524 may review the fund transfer request and determine if the fund transfer request is determined to be fraudulent. At step 644, the monitoring platform 510 may receive, from the enterprise user computing device 524, an indication of whether the fund transfer request is fraudulent. In an arrangement, steps 640 and 644 may be skipped and the ML engine 516 itself may be used to determine (based on the parameters) whether the fund transfer request is fraudulent. This may reduce manual oversight and reduce time required for detecting fraudulent fund transfers and processing legitimate fund transfers.

At step 648, the monitoring engine 512 may update/validate accounts listed in the mule database 520 based on a determination that the fund transfer request is fraudulent. A source account and/or a destination account associated with fund transfer request may be added to the mule account database 520 (e.g., if not already present). Accounts in the mule account database 520 may be validated (as being in active use for fraudulent transfers) if they match with accounts associated with the fund transfer request. At step 652, the monitoring platform 510 may cancel the fund transfer request if the fund transfer request is determined to be fraudulent. If fund transfer request is determined to be not fraudulent, the monitoring engine 512 may approve the fund transfer request and send a notification to server(s) associated with the fund transfer system 508 to process the fund transfer request.

FIG. 7 shows an example event sequence for supervised machine learning of an ML engine associated with a monitoring platform. At step 712, a user device 504 may send a request for a fund transfer to the monitoring platform 512. The funds transfer may be from accounts associated with a source financial institution to accounts associated with destination financial institution(s). In an example, the monitoring platform 510 may be associated with the source financial institution. At step 716, the monitoring engine 512 may determine if the fund transfer request involves accounts listed in the mule account database 520. The monitoring engine 512 may compare the accounts associated with the fund transfer request (source account and/or destination account) with accounts in the mule account database 520. If none of the accounts with the fund transfer request is listed in the mule account database 520, the monitoring engine 512 may approve the fund transfer request and send a notification to server(s) associated with the fund transfer system 508 to process the fund transfer request. If an account associated with a fund transfer request is listed in the mule account database 520, the parameters associated with the fund transfer request (e.g., event date, an amount, an entry date, a beneficiary name, a memo field, etc.) may be sent to the enterprise user computing device 524 for manual review (step 720).

A user associated with the enterprise user computing device 524, a user associated with the enterprise user computing device 524 may review the fund transfer request and determine if the fund transfer request is determined to be fraudulent (e.g., based on the parameters). At step 724, the monitoring platform 510 may receive, from the enterprise user computing device 524, an indication of whether the fund transfer request is fraudulent.

At step 728, the monitoring engine 512 may send, to the ML engine 516, the parameters of the fund transfer request along with an indication of whether the fund transfer request is fraudulent. The ML engine 516 may use the indication and parameters for training a neural network (e.g., in accordance with procedures of supervised machine learning as described with reference to FIG. 9). For example, the ML engine 516 At step 732, and if the fund transfer request is determined to be not fraudulent, the monitoring platform 510 may send a notification, to server(s) associated with the fund transfer system 508, to process the fund transfer request. At step 736, and if the fund transfer request is determined to be fraudulent, the monitoring platform 510 may cancel the fund transfer request. The various steps described here for training the IA model may be used in example arrangements described with reference to FIGS. 3-6.

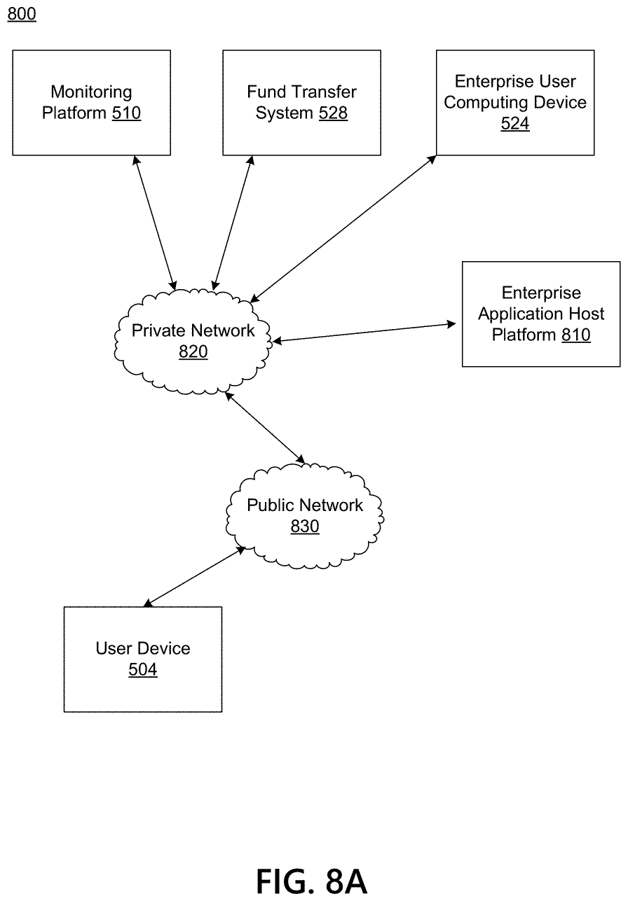

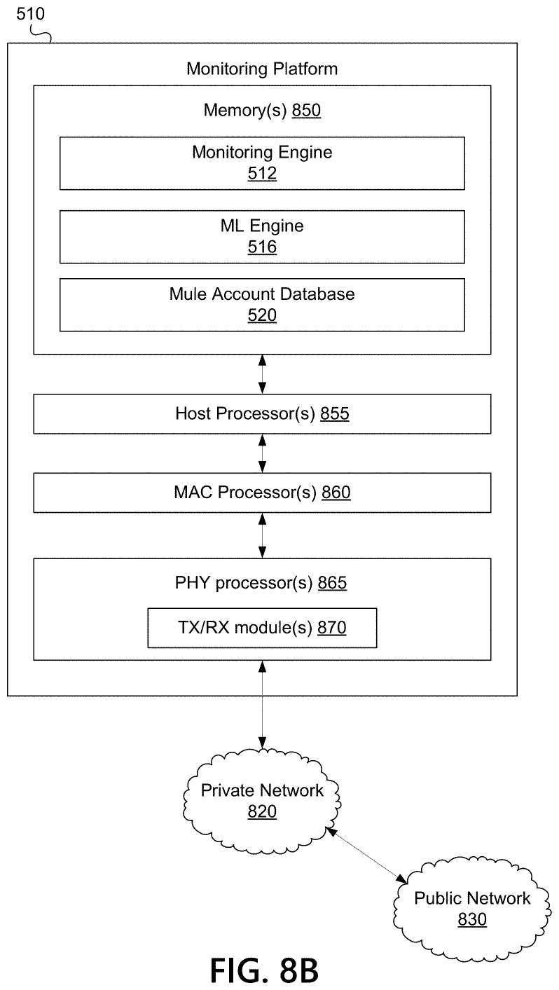

FIG. 8A shows an illustrative computing environment 800 for determination of fraudulent transfers, in accordance with one or more arrangements. The computing environment 800 may comprise one or more devices (e.g., computer systems, communication devices, and the like). The computing environment 800 may comprise, for example, an enterprise application host platform 810, an enterprise user computing device 524, the fund transfer system 528, the monitoring platform 510, and/or the user device 504. The one or more of the devices and/or systems, may be linked over a private network 820 associated with an enterprise organization (e.g., a financial institution). The computing environment 100 may additionally comprise the user device 504 connected, via a public network 830, to the devices in the private network 820. The devices in the computing environment 800 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3^{rd} Generation Partnership Project (3GPP) cellular protocol, a hypertext transfer protocol (HTTP), etc.).

The enterprise application host platform 810 may comprise one or more computing devices and/or other computer components (e.g., processors, memories, communication interfaces). In addition, the enterprise application host platform 810 may be configured to host, execute, and/or otherwise provide one or more enterprise applications. For example, the enterprise application host platform 810 may be configured to host, execute, and/or otherwise provide one or more transaction processing programs, such as an online banking application, fund transfer applications, and/or other programs associated with the financial institution. The enterprise application host platform 810 may comprise various servers and/or databases that store and/or otherwise maintain account information, such as financial account information including account balances, transaction history, account owner information, and/or other information. In addition, the enterprise application host platform 810 may process and/or otherwise execute transactions on specific accounts based on commands and/or other information received from other computer systems comprising the computing environment 800.

The enterprise user computing device 524 may be a personal computing device (e.g., desktop computer, laptop computer) or mobile computing device (e.g., smartphone, tablet). In addition, the enterprise user computing device 524 may be linked to and/or operated by a specific enterprise user (who may, for example, be an employee or other affiliate of the enterprise organization).

The computing environment 800 may comprise a fund transfer system 528. The fund transfer system 528 may comprise applications, servers, and/or databases (hereinafter referred to as assets) that facilitate fund transfers between different financial institutions.

The user device 504 may be a computing device (e.g., desktop computer, laptop computer) or mobile computing device (e.g., smartphone, tablet). The user device 504 may be configured to enable the user to access the various functionalities provided by the devices, applications, and/or systems in the private network 155.

In one or more arrangements, the enterprise application host platform 810, the enterprise user computing device 524, the fund transfer system 528, the user device 504, the monitoring platform 510, and/or the other devices/systems in the computing environment 800 may be any type of computing device capable of receiving input via a user interface, and communicating the received input to one or more other computing devices in the computing environment 800. For example, the enterprise application host platform 810, the enterprise user computing device 524, the fund transfer system 528, the user device 504, the monitoring platform 510, and/or the other devices/systems in the computing environment 800 may, in some instances, be and/or include server computers, desktop computers, laptop computers, tablet computers, smart phones, wearable devices, or the like that may comprised of one or more processors, memories, communication interfaces, storage devices, and/or other components. In one or more arrangements, the enterprise application host platform 810, the enterprise user computing device 524, the fund transfer system 528, the user device 504, the monitoring platform 510, and/or the other devices/systems in the computing environment 800 may be any type of display device, audio system, wearable devices (e.g., a smart watch, fitness tracker, etc.). Any and/or all of the enterprise application host platform 810, the enterprise user computing device 524, the fund transfer system 528, the user device 504, the monitoring platform 510, and/or the other devices/systems in the computing environment 800 may, in some instances, be and/or comprise special-purpose computing devices configured to perform specific functions.

FIG. 8B shows an example monitoring platform 510 in accordance with one or more examples described herein. The monitoring platform 510 may comprise one or more of host processor(s) 855, medium access control (MAC) processor(s) 860, physical layer (PHY) processor(s) 865, transmit/receive (TX/RX) module(s) 870, memory 850, and/or the like. One or more data buses may interconnect host processor(s) 855, MAC processor(s) 860, PHY processor(s) 865, and/or Tx/Rx module(s) 870, and/or memory 850. The monitoring platform 510 may be implemented using one or more integrated circuits (ICs), software, or a combination thereof, configured to operate as discussed below. The host processor(s) 855, the MAC processor(s) 860, and the PHY processor(s) 865 may be implemented, at least partially, on a single IC or multiple ICs. Memory 850 may be any memory such as a random-access memory (RAM), a read-only memory (ROM), a flash memory, or any other electronically readable memory, or the like.

Messages transmitted from and received at devices in the computing environment 800 may be encoded in one or more MAC data units and/or PHY data units. The MAC processor(s) 860 and/or the PHY processor(s) 865 of the monitoring platform 510 may be configured to generate data units, and process received data units, that conform to any suitable wired and/or wireless communication protocol. For example, the MAC processor(s) 860 may be configured to implement MAC layer functions, and the PHY processor(s) 865 may be configured to implement PHY layer functions corresponding to the communication protocol. The MAC processor(s) 860 may, for example, generate MAC data units (e.g., MAC protocol data units (MPDUs)), and forward the MAC data units to the PHY processor(s) 865. The PHY processor(s) 865 may, for example, generate PHY data units (e.g., PHY protocol data units (PPDUs)) based on the MAC data units. The generated PHY data units may be transmitted via the TX/RX module(s) 870 over the private network 155. Similarly, the PHY processor(s) 865 may receive PHY data units from the TX/RX module(s) 865, extract MAC data units encapsulated within the PHY data units, and forward the extracted MAC data units to the MAC processor(s). The MAC processor(s) 860 may then process the MAC data units as forwarded by the PHY processor(s) 865.

One or more processors (e.g., the host processor(s) 855, the MAC processor(s) 860, the PHY processor(s) 865, and/or the like) of the monitoring platform 510 may be configured to execute machine readable instructions stored in memory 850. The memory 850 may comprise (i) one or more program modules/engines having instructions that when executed by the one or more processors cause the monitoring platform 510 to perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the monitoring platform 510 and/or by different computing devices that may form and/or otherwise make up the monitoring platform 510. For example, the memory 850 may have, store, and/or comprise the monitoring engine 512, the ML engine 516, and/or the mule account database 520. The monitoring engine 512 and/or the ML engine 516 may have instructions that direct and/or cause the monitoring platform 510 to perform one or more operations of the monitoring platform 510 as discussed herein with reference to FIGS. 3-7. The mule account database 520 may store a listing of account known to be associated with malicious and/or suspicious activity.

While FIG. 8A illustrates the enterprise application host platform 810, the enterprise user computing device 524, the monitoring platform 510, and the fund transfer system 528 as being separate elements connected in the private network 820, in one or more other arrangements, functions of one or more of the above may be integrated in a single device/network of devices. For example, elements in the monitoring platform 510 (e.g., host processor(s) 855, memory(s) 850, MAC processor(s) 860, PHY processor(s) 865, TX/RX module(s) 870, and/or one or more program/modules stored in memory(s) 850) may share hardware and software elements with and corresponding to, for example, the enterprise application host platform 810, the enterprise user computing device 524, the monitoring platform 510, and the fund transfer system 528.

FIG. 9 illustrates a simplified example of an artificial neural network 900 on which a machine learning algorithm may be executed. The machine learning algorithm may be used at the ML engine 516 to perform one or more functions of the monitoring platform 510, as described herein. FIG. 9 is merely an example of nonlinear processing using an artificial neural network; other forms of nonlinear processing may be used to implement a machine learning algorithm in accordance with features described herein.

In one example, a framework for a machine learning algorithm may involve a combination of one or more components, sometimes three components: (1) representation, (2) evaluation, and (3) optimization components. Representation components refer to computing units that perform steps to represent knowledge in different ways, including but not limited to as one or more decision trees, sets of rules, instances, graphical models, neural networks, support vector machines, model ensembles, and/or others. Evaluation components refer to computing units that perform steps to represent the way hypotheses (e.g., candidate programs) are evaluated, including but not limited to as accuracy, prediction and recall, squared error, likelihood, posterior probability, cost, margin, entropy k-L divergence, and/or others. Optimization components refer to computing units that perform steps that generate candidate programs in different ways, including but not limited to combinatorial optimization, convex optimization, constrained optimization, and/or others. In some embodiments, other components and/or sub-components of the aforementioned components may be present in the system to further enhance and supplement the aforementioned machine learning functionality.

Machine learning algorithms sometimes rely on unique computing system structures. Machine learning algorithms may leverage neural networks, which are systems that approximate biological neural networks. Such structures, while significantly more complex than conventional computer systems, are beneficial in implementing machine learning. For example, an artificial neural network may be comprised of a large set of nodes which, like neurons, may be dynamically configured to effectuate learning and decision-making.

Machine learning tasks are sometimes broadly categorized as either unsupervised learning or supervised learning. In unsupervised learning, a machine learning algorithm is left to generate any output (e.g., to label as desired) without feedback. The machine learning algorithm may teach itself (e.g., observe past output), but otherwise operates without (or mostly without) feedback from, for example, a human administrator.

Meanwhile, in supervised learning, a machine learning algorithm is provided feedback on its output. Feedback may be provided in a variety of ways, including via active learning, semi-supervised learning, and/or reinforcement learning. In active learning, a machine learning algorithm is allowed to query answers from an administrator. For example, the machine learning algorithm may make a guess in a face detection algorithm, ask an administrator to identify the photo in the picture, and compare the guess and the administrator's response. In semi-supervised learning, a machine learning algorithm is provided a set of example labels along with unlabeled data. For example, the machine learning algorithm may be provided a data set of 1000 photos with labeled human faces and 10,000 random, unlabeled photos. In reinforcement learning, a machine learning algorithm is rewarded for correct labels, allowing it to iteratively observe conditions until rewards are consistently earned. For example, for every face correctly identified, the machine learning algorithm may be given a point and/or a score (e.g., “95% correct”).

One theory underlying supervised learning is inductive learning. In inductive learning, a data representation is provided as input samples data (x) and output samples of the function (f(x)). The goal of inductive learning is to learn a good approximation for the function for new data (x), i.e., to estimate the output for new input samples in the future. Inductive learning may be used on functions of various types: (1) classification functions where the function being learned is discrete; (2) regression functions where the function being learned is continuous; and (3) probability estimations where the output of the function is a probability.

In practice, machine learning systems and their underlying components are tuned by data scientists to perform numerous steps to perfect machine learning systems. The process is sometimes iterative and may entail looping through a series of steps: (1) understanding the domain, prior knowledge, and goals; (2) data integration, selection, cleaning, and pre-processing; (3) learning models; (4) interpreting results; and/or (5) consolidating and deploying discovered knowledge. This may further include conferring with domain experts to refine the goals and make the goals more clear, given the nearly infinite number of variables that can possible be optimized in the machine learning system. Meanwhile, one or more of data integration, selection, cleaning, and/or pre-processing steps can sometimes be the most time consuming because the old adage, “garbage in, garbage out,” also reigns true in machine learning systems.

By way of example, in FIG. 9, each of input nodes 910a-n is connected to a first set of processing nodes 920a-n. Each of the first set of processing nodes 920a-n is connected to each of a second set of processing nodes 930a-n. Each of the second set of processing nodes 930a-n is connected to each of output nodes 940a-n. Though only two sets of processing nodes are shown, any number of processing nodes may be implemented. Similarly, though only four input nodes, five processing nodes, and two output nodes per set are shown in FIG. 9, any number of nodes may be implemented per set. Data flows in FIG. 9 are depicted from left to right: data may be input into an input node, may flow through one or more processing nodes, and may be output by an output node. Input into the input nodes 910a-n may originate from an external source 960. The input from the input nodes may be, for example, parameters associated with a fund transfer request or a processed fund transfer (e.g., event date, amount, a source/debit account number, an entry date, destination/beneficiary account number, beneficiary name, memo field, etc.). Output may be sent to a feedback system 950 and/or to storage 970. The output from an output node may be an indication of whether the fund transfer/fund transfer request is suspicious (and required manual review) or fraudulent. The output from an output node may be a notification to a fund transfer system to cancel a requested fund transfer or recall a processed fund transfer. The output from an output node may be a notification to a computing device to manually review the fund transfer request/processed fund transfer. The feedback system 950 may send output to the input nodes 910a-n for successive processing iterations with the same or different input data.

In one illustrative method using feedback system 950, the system may use machine learning to determine an output. The system may use one of a myriad of machine learning models including xg-boosted decision trees, auto-encoders, perceptron, decision trees, support vector machines, regression, and/or a neural network. The neural network may be any of a myriad of type of neural networks including a feed forward network, radial basis network, recurrent neural network, long/short term memory, gated recurrent unit, auto encoder, variational autoencoder, convolutional network, residual network, Kohonen network, and/or other type. In one example, the output data in the machine learning system may be represented as multi-dimensional arrays, an extension of two-dimensional tables (such as matrices) to data with higher dimensionality.

The neural network may include an input layer, a number of intermediate layers, and an output layer. Each layer may have its own weights. The input layer may be configured to receive as input one or more feature vectors described herein. The intermediate layers may be convolutional layers, pooling layers, dense (fully connected) layers, and/or other types. The input layer may pass inputs to the intermediate layers. In one example, each intermediate layer may process the output from the previous layer and then pass output to the next intermediate layer. The output layer may be configured to output a classification or a real value. In one example, the layers in the neural network may use an activation function such as a sigmoid function, a Tan h function, a ReLu function, and/or other functions. Moreover, the neural network may include a loss function. A loss function may, in some examples, measure a number of missed positives; alternatively, it may also measure a number of false positives. The loss function may be used to determine error when comparing an output value and a target value. For example, when training the neural network the output of the output layer may be used as a prediction and may be compared with a target value of a training instance to determine an error. The error may be used to update weights in each layer of the neural network.

In one example, the neural network may include a technique for updating the weights in one or more of the layers based on the error. The neural network may use gradient descent to update weights. Alternatively, the neural network may use an optimizer to update weights in each layer. For example, the optimizer may use various techniques, or combination of techniques, to update weights in each layer. When appropriate, the neural network may include a mechanism to prevent overfitting— regularization (such as L1 or L2), dropout, and/or other techniques. The neural network may also increase the amount of training data used to prevent overfitting.

Once data for machine learning has been created, an optimization process may be used to transform the machine learning model. The optimization process may include (1) training the data to predict an outcome, (2) defining a loss function that serves as an accurate measure to evaluate the machine learning model's performance, (3) minimizing the loss function, such as through a gradient descent algorithm or other algorithms, and/or (4) optimizing a sampling method, such as using a stochastic gradient descent (SGD) method where instead of feeding an entire dataset to the machine learning algorithm for the computation of each step, a subset of data is sampled sequentially.

In one example, FIG. 9 depicts nodes that may perform various types of processing, such as discrete computations, computer programs, and/or mathematical functions implemented by a computing device. For example, the input nodes 910a-n may comprise logical inputs of different data sources, such as one or more data servers. The processing nodes 920a-n may comprise parallel processes executing on multiple servers in a data center. And, the output nodes 940a-n may be the logical outputs that ultimately are stored in results data stores, such as the same or different data servers as for the input nodes 910a-n. Notably, the nodes need not be distinct. For example, two nodes in any two sets may perform the exact same processing. The same node may be repeated for the same or different sets.

Each of the nodes may be connected to one or more other nodes. The connections may connect the output of a node to the input of another node. A connection may be correlated with a weighting value. For example, one connection may be weighted as more important or significant than another, thereby influencing the degree of further processing as input traverses across the artificial neural network. Such connections may be modified such that the artificial neural network 900 may learn and/or be dynamically reconfigured. Though nodes are depicted as having connections only to successive nodes in FIG. 9, connections may be formed between any nodes. For example, one processing node may be configured to send output to a previous processing node.

Input received in the input nodes 910a-n may be processed through processing nodes, such as the first set of processing nodes 920a-n and the second set of processing nodes 930a-n. The processing may result in output in output nodes 940a-n. As depicted by the connections from the first set of processing nodes 920a-n and the second set of processing nodes 930a-n, processing may comprise multiple steps or sequences. For example, the first set of processing nodes 920a-n may be a rough data filter, whereas the second set of processing nodes 930a-n may be a more detailed data filter.

The artificial neural network 900 may be configured to effectuate decision-making. As a simplified example for the purposes of explanation, the artificial neural network 900 may be configured to detect faces in photographs. The input nodes 910a-n may be provided with a digital copy of a photograph. The first set of processing nodes 920a-n may be each configured to perform specific steps to remove non-facial content, such as large contiguous sections of the color red. The second set of processing nodes 930a-n may be each configured to look for rough approximations of faces, such as facial shapes and skin tones. Multiple subsequent sets may further refine this processing, each looking for further more specific tasks, with each node performing some form of processing which need not necessarily operate in the furtherance of that task. The artificial neural network 900 may then predict the location on the face. The prediction may be correct or incorrect.

The feedback system 950 may be configured to determine whether or not the artificial neural network 900 made a correct decision. Feedback may comprise an indication of a correct answer and/or an indication of an incorrect answer and/or a degree of correctness (e.g., a percentage). For example, in the facial recognition example provided above, the feedback system 950 may be configured to determine if the face was correctly identified and, if so, what percentage of the face was correctly identified. The feedback system 950 may already know a correct answer, such that the feedback system may train the artificial neural network 900 by indicating whether it made a correct decision. The feedback system 950 may comprise human input, such as an administrator telling the artificial neural network 900 whether it made a correct decision. The feedback system may provide feedback (e.g., an indication of whether the previous output was correct or incorrect) to the artificial neural network 900 via input nodes 910a-n or may transmit such information to one or more nodes. The feedback system 950 may additionally or alternatively be coupled to the storage 970 such that output is stored. The feedback system may not have correct answers at all, but instead base feedback on further processing: for example, the feedback system may comprise a system programmed to identify faces, such that the feedback allows the artificial neural network 900 to compare its results to that of a manually programmed system.

The artificial neural network 900 may be dynamically modified to learn and provide better input. Based on, for example, previous input and output and feedback from the feedback system 950, the artificial neural network 900 may modify itself. For example, processing in nodes may change and/or connections may be weighted differently. Following on the example provided previously, the facial prediction may have been incorrect because the photos provided to the algorithm were tinted in a manner which made all faces look red. As such, the node which excluded sections of photos containing large contiguous sections of the color red could be considered unreliable, and the connections to that node may be weighted significantly less. Additionally or alternatively, the node may be reconfigured to process photos differently. The modifications may be predictions and/or guesses by the artificial neural network 900, such that the artificial neural network 900 may vary its nodes and connections to test hypotheses.

The artificial neural network 900 need not have a set number of processing nodes or number of sets of processing nodes, but may increase or decrease its complexity. For example, the artificial neural network 900 may determine that one or more processing nodes are unnecessary or should be repurposed, and either discard or reconfigure the processing nodes on that basis. As another example, the artificial neural network 900 may determine that further processing of all or part of the input is required and add additional processing nodes and/or sets of processing nodes on that basis.

The feedback provided by the feedback system 950 may be mere reinforcement (e.g., providing an indication that output is correct or incorrect, awarding the machine learning algorithm a number of points, or the like) or may be specific (e.g., providing the correct output). For example, the machine learning algorithm 900 may be asked to detect faces in photographs. Based on an output, the feedback system 950 may indicate a score (e.g., 75% accuracy, an indication that the guess was accurate, or the like) or a specific response (e.g., specifically identifying where the face was located).

The artificial neural network 900 may be supported or replaced by other forms of machine learning. For example, one or more of the nodes of artificial neural network 900 may implement a decision tree, associational rule set, logic programming, regression model, cluster analysis mechanisms, Bayesian network, propositional formulae, generative models, and/or other algorithms or forms of decision-making. The artificial neural network 900 may effectuate deep learning.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein describe threat detection using a validation server and based on hash analysis. Using the validation server may ensure reduced resource utilization at a user device and use of updated hash databases. Further, hash analysis may ensure that an entire element of a DOM need not necessarily be sent for analysis. The validation server (and/or other servers) may be configured to implement countermeasures based on risks associated with a particular user/webpage, enabling prioritization of more urgent/significant threats.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

1. A machine learning system to filter false positive fund transfers, the system comprising:
a mule account database with a listing of accounts;
a user computer device configured to send a request for a fund transfer, wherein the request comprises an indication of a source account, an indication of a destination account, and an indication of a transfer value;
a machine learning (ML) engine trained using supervised machine learning based on transfer information and response notifications; and
a monitoring platform configured to:
compare the source account and the destination account with accounts listed in the mule account database;
based on at least one of the source account and the destination account matching the accounts listed in the mule account database, send first transfer information to an enterprise user computing device, wherein the first transfer information comprises:
the indication of the source account,
the indication of the destination account,
the indication of the transfer value, and
indications of transfer parameters associated with the request;
receive, from the enterprise user computing device, a response notification, wherein the response notification indicates whether the request is for a fraudulent fund transfer, and wherein the response notification is used as a feedback signal for the ML engine; and
send, to a server associated with a fund transfer network and based on receiving the response notification, a transfer notification that causes the fund transfer network to process the request for the fund transfer.

2. The system of claim 1, wherein the transfer parameters comprise one of:
a date of the request;
a date of entry of the source account in the mule account database;
a date of entry of the destination account in the mule account database;
a beneficiary name associated with the destination account;
contents of a memo field in the request; and
combinations thereof.

3. The system of claim 1, wherein:
the response notification indicates that the request is for a fraudulent fund transfer;
the transfer notification indicates cancelation of the request; and
the server associated with the fund transfer network cancels the request based on the transfer notification.

4. The system of claim 3, wherein the monitoring platform is further configured to:
based on the response notification indicating that the request for the fund transfer is for a fraudulent fund transfer and at least one of the source account and the destination account not being listed in the mule account database, add the at least one of the source account and the destination account to the mule account database.

5. The system of claim 1, wherein:
the response notification indicates that the request is approved;
the transfer notification indicates that the request is approved; and
the server associated with the fund transfer network approves the request based on the transfer notification.

6. The system of claim 1, further comprising a second user computer device configured to send a second request for a second fund transfer, wherein the second request comprises:
an indication of a second source account;
an indication of a second destination account; and
an indication of a second transfer value;
wherein the monitoring platform is further configured to:
receive the second request;
compare the second source account and the second destination account with accounts listed in the mule account database;
based on at least one of the second source account and the second destination account matching the accounts listed in the mule account database, use the ML engine to determine whether the second request is for a fraudulent fund transfer, wherein determining whether the second request is for a fraudulent fund transfer is based on:
the second transfer value, and
second transfer parameters associated with the second request; and
send, to the server associated with a fund transfer network and based on determining whether the second request is for a fraudulent fund transfer, a second transfer notification.

7. The system of claim 6, wherein the second transfer parameters comprise one of:
a date of the second request;
a date of entry of the second source account in the mule account database;
a date of entry of the second destination account in the mule account database;
a beneficiary name associated with the second destination account;
contents of a memo field in the second request; and
combinations thereof.

8. A method for filtering false positive fund transfers, the method comprising:
training a machine learning (ML) engine using supervised machine learning based on transfer information and response notifications;
receiving, at a monitoring platform associated with an electronic fund transfer system, a request for a fund transfer, wherein the request comprises:
an indication of a source account,
an indication of a destination account, and
an indication of a transfer value;
comparing the source account and the destination account with accounts listed in a mule account database associated with the monitoring platform;
based on at least one of the source account and the destination account matching the accounts listed in the mule account database, sending first transfer information to an enterprise user computing device, wherein the first transfer information comprises:
the indication of the source account,
the indication of the destination account,
the indication of the transfer value, and
indications of transfer parameters;
receiving, from the enterprise user computing device, a response notification, wherein the response notification indicates whether the request is for a fraudulent fund transfer, and wherein the response notification is used as a feedback signal for the ML engine; and
sending, to a server associated with a fund transfer network and based on receiving the response notification, a transfer notification that causes the fund transfer network to process the request for the fund transfer.

9. The method of claim 8, wherein the transfer parameters comprise one of:
a date of the request;
a date of entry of the source account in the mule account database;
a date of entry of the destination account in the mule account database;
a beneficiary name associated with the destination account;
contents of a memo field in the request; and
combinations thereof.

10. The method of claim 8, wherein:
the response notification indicates that the request is for a fraudulent fund transfer;
the transfer notification indicates cancelation of the request; and
the server associated with the fund transfer network cancels the request based on the transfer notification.

11. The method of claim 10, further comprising:
based on the response notification indicating that the request is for a fraudulent fund transfer and at least one of the source account and the destination account not being listed in the mule account database, adding the at least one of the source account and the destination account to the mule account database.

12. The method of claim 8, wherein:
the response notification indicates that the request is approved;
the transfer notification indicates that the request is approved; and
the server associated with the fund transfer network approves the request based on the transfer notification.

13. The method of claim 8, further comprising:
receiving a second request for a second fund transfer, wherein the second request comprises:
an indication of a second source account;
an indication of a second destination account; and
an indication of a second transfer value;
comparing the second source account and the second destination account with accounts listed in the mule account database;
based on at least one of the second source account and the second destination account matching the accounts listed in the mule account database, using the ML engine to determine whether the second request is for a fraudulent fund transfer, wherein determining whether the second request is for a fraudulent fund transfer is based on:
the second transfer value, and
second transfer parameters associated with the second request; and
send, to the server associated with a fund transfer network and based on determining whether the second request is for a fraudulent fund transfer, a second transfer notification.

14. The method of claim 13, wherein the second transfer parameters comprise one of:
a date of the second request;
a date of entry of the second source account in the mule account database;
a date of entry of the second destination account in the mule account database;
a beneficiary name associated with the second destination account;
contents of a memo field in the request; and
combinations thereof.

15. A non-transitory computer-readable medium storing computer-executable instructions that, when executed by a computer processor, causes a computer system to:
receive a request for a fund transfer, wherein the request comprises:
an indication of a source account,
an indication of a destination account, and
an indication of a transfer value;
compare the source account and the destination account with accounts listed in a mule account database associated with a monitoring platform;
based on at least one of the source account and the destination account matching the accounts listed in the mule account database, send transfer information to an enterprise user computing device, wherein the transfer information comprises:
the indication of the source account,
the indication of the destination account,
the indication of the transfer value, and
indications of transfer parameters;
receive, from the enterprise user computing device, a response notification, wherein the response notification indicates whether the request is for a fraudulent fund transfer;
train a machine learning (ML) engine using supervised ML based on the transfer information and the response notification; and
send, to a server associated with a fund transfer network and based on receiving the response notification, a transfer notification.

16. The non-transitory computer-readable medium of claim 15, wherein the transfer parameters comprise one of:
a date of the request;
a date of entry of the source account in the mule account database;
a date of entry of the destination account in the mule account database;
a beneficiary name associated with the destination account;
contents of a memo field in the request; and
combinations thereof.

17. The non-transitory computer-readable medium of claim 15, wherein:
the response notification indicates that the request is for a fraudulent fund transfer; and
the transfer notification indicates cancelation of the request.

18. The non-transitory computer-readable medium of claim 16, wherein the instructions, when executed by the computer processor, causes the computer system to:
based on the response notification indicating that the request is for a fraudulent fund transfer and at least one of the source account and the destination account not being listed in the mule account database, add the at least one of the source account and the destination account to the mule account database.

19. The non-transitory computer-readable medium of claim 15, wherein the instructions, when executed by the computer processor, causes the computer system to:
receive a second request for a second fund transfer, wherein the second request comprises:
an indication of a second source account;
an indication of a second destination account; and
an indication of a second transfer value;
compare the second source account and the second destination account with accounts listed in the mule account database;
based on at least one of the second source account and the second destination account matching the accounts listed in the mule account database, use the ML engine to determine whether the second request is for a fraudulent fund transfer, wherein determining whether the second request is for a fraudulent fund transfer is based on:
the second transfer value, and
second transfer parameters associated with the second request; and
send, to the server associated with a fund transfer network and based on determining whether the second request is for a fraudulent fund transfer, a second transfer notification.

20. The non-transitory computer-readable medium of claim 19, wherein the second transfer parameters comprise one of:
a date of the second request;
a date of entry of the second source account in the mule account database;
a date of entry of the second destination account in the mule account database;
a beneficiary name associated with the second destination account;
contents of a memo field in the request; and
combinations thereof.
